(19) United States
(12) Patent Application Publication
(10) Pub. No.: US 2008/0067285 A1
(43) Pub. Date: Mar. 20, 2008

(54) CAPTIVE BALLOON ASSEMBLIES AND METHODS OF USING SAME

(75) Inventors: Matthieu Gobbi, Paris (FR); Jerome Giacomoni, Saint Cloud (FR)

Correspondence Address: BELL, BOYD & LLOYD, LLP, P.O. Box 1135, CHICAGO, IL, 60690, US

(73) Assignee: AEROGROUPE S.A.R.L., Chantilly (FR)

(21) Appl. No.: 11/851,249

(22) Filed: Sep. 6, 2007

Related U.S. Application Data
(63) Continuation-in-part of application No. PCT/FR2006/000505, filed on Mar. 7, 2006.

(30) Foreign Application Priority Data
Mar. 8, 2005 (FR) 0502299
Oct. 21, 2005 (FR) 0510755

(51) Int. Cl. B64B 1/50

(52) U.S. Cl. 244/33; 40/584

(57) ABSTRACT

Captive balloon assemblies and methods of using the captive balloon assemblies are presented. In an embodiment, the present disclosure provides a method of entertaining. The method comprises providing an assembly comprising a balloon, a tower and a cable driving system. The balloon comprises one or more seats and is captive and mobile in the tower. One or more persons are placed in the seat, and the balloon is caused to ascend within the tower by the cable driving system. The balloon assembly can also be used to generate revenue and display one or more advertisements.

### CROSS-REFERENCE TO RELATED APPLICATIONS

This application is a continuation-in-part of International application no. PCT/FR2006/000505 filed Mar. 7, 2006, the entire content of which is expressly incorporated herein by reference thereto.

### BACKGROUND

The present disclosure generally relates to amusement and related rides.

Document FR-A-2 758 789 describes a captive balloon and a method for stabilizing a balloon of this type. A captive balloon comprises an inflatable lifting envelope connected to a load frame by rigging lines and means for returning the balloon to the ground. The lifting envelope is generally inflated with a gas that is lighter than air, which allows the balloon to rise naturally. The means for returning the balloon to the ground can comprise one or more cables fixed to the load frame and winding onto a ground winch system, allowing the ascent and descent of the captive balloon to be controlled.

Commercial operation of captive balloons depends greatly on the weather conditions, in particular the wind factor; excessively strong gusts of wind cause the balloon to swing and make its ascent dangerous, even when empty.

Document FR-A-2 758 789 mentioned above proposes a system for stabilising the balloon, allowing it to rise even in difficult weather conditions. The system described in this document includes means for lateral stabilization of the balloon in flight, comprising at least one cable fixed to the balloon and connected to the ground in order to exert on the balloon a braking force opposing a lateral movement caused by the wind.

However, the system described in this document is complex and cumbersome. It is shown that for a balloon 22 m in diameter, the south pole of which is situated approximately 15 m from the ground, three cables are necessary to stabilize the balloon effectively, with a distance of 40 m between each winch of the stabilization means and the winch of the return means. The balloon with its stabilization system therefore occupies a surface area of approximately 5,000 m².

Therefore there is a need for a balloon which can be ascended independently of the weather conditions without requiring a large and cumbersome stabilization device.

### SUMMARY

The present disclosure relates to amusement and related rides and more specifically, in an preferred embodiment, to captive balloon assemblies and methods of using the captive balloon assemblies. For example, various embodiments of the present disclosure can be used to provide entertainment, generate revenue and display advertisements. In an embodiment, the present disclosure provides a method of providing entertainment. This method comprises providing an assembly comprising a transporter that includes a sufficient amount of gas that allows the transporter to ascend and a tower for constraining movement of the transporter. The transporter can be captive and mobile in the tower. One or more persons can be placed in the transporter, and the transporter can be moved in part to ascend or descend within the tower. In another embodiment, the assembly comprises a tether and the transporter is moved at least in part within the tower by the tether.

The transporter can be held and guided, for example, by the structure of the tower and/or the tether. The tower can have a closed perimeter. The captive transporter in the tower can therefore rise and fall the length of the tower. The tower can comprise guide rails to receive carriages integral with the transporter in order to move the balloon in the tower.

In an embodiment, the transporter comprises a balloon comprising at least one seat.

In an embodiment, the method comprises charging the person a fee for riding in the transporter.

In an embodiment, the method comprises rotating the transporter at least 360 degrees as the transporter is ascending within the tower.

In an embodiment, the transporter remains ascended in the air within the tower for at least 3 minutes.

In an embodiment, the transporter comprises advertising on an external surface of the transporter and/or the tower.

In an embodiment, the method comprises demonstrating how the assembly operates through a medium selected from the group consisting of written materials, television, the internet and combinations thereof.

In an embodiment, the method comprises providing a sheltered waiting area at a base of the tower for people waiting to ride the transporter.

In an embodiment, the assembly is located at an amusement park, a tourist attraction, a park, a shopping mall or other suitable location.

In an embodiment, the tower comprises at least one translucent panel forming a wall in the tower and one or more advertisements are displayed on the translucent panel.

In another embodiment, the present disclosure provides a method for generating revenue, for example, from a balloon ride. This method comprises providing an assembly comprising a balloon, a tower and a cable driving system and charging a fee for riding the balloon. The balloon can comprise one or more seats and be captive and mobile in the tower.

In an embodiment, the fee is received through sales of tickets for the ride.

In an embodiment, the fee is received through renting the balloon assembly.

In an embodiment, the fee is received through licensing the balloon assembly.

In an embodiment, the method comprises selling at least one souvenir associated with the balloon assembly.

In an embodiment, the method comprises charging a fee for transporting the balloon assembly from a first location to a second location.

In an embodiment, the method comprises providing a waiting area comprising at least one television at a base of the tower for people waiting to ride the balloon and receiving a fee from advertising on the television.

In an embodiment, the method comprises receiving a fee for advertising on an external surface of the balloon, the seat(s) and/or the tower.

In an alternative embodiment, the present disclosure provides a method of advertising. This method comprises providing an assembly comprising a balloon, a tower and a cable driving system. The balloon is captive and mobile in the tower. One or more advertisements can be displayed on an external surface of the balloon and/or the tower. The balloon can be moved to ascend or descend within the tower by the cable driving system so as to allow the advertisement to be observed.

In an embodiment, the advertisement is in a form selected from the group consisting of pictures, slogans, trademarks and combinations thereof.

In an embodiment, the method comprises charging a fee for displaying the advertisement.

In an embodiment, the balloon comprises one or more seats and an advertisement is displayed on an external surface of the seat(s), the balloon and/or the tower.

In an embodiment, the balloon assembly according to the disclosure comprises one or more of the following features:

the tower includes a metal structure comprising at least three vertical posts;

the tower is cylindrical with a circular or polygonal base;

the tower has a closed perimeter and/or a closed top;

the tower includes translucent panels forming walls;

the balloon has a spherical or substantially oval shape;

the ratio of the height of the balloon to its width is comprised between 1.2 and 4;

the balloon has a diameter at the equator comprised between 8 m and 18 m;

the overpressure at the south pole of the balloon is less than or equal to 50 Pa;

the height of the tower is comprised between 30 m and 80 m;

the internal diameter of the tower is substantially equal to the diameter of the equator of the balloon;

the balloon has reinforcements on the equator;

the balloon has rollers elements arranged on the equator;

the tower comprises rollers elements on its internal wall which can be placed in each corner of a polygonal tower;

the roller element have an axis of rotation which extends in a direction comprised between 0° and 30° to the horizontal;

at least three carriages integral with the balloon;

the balloon is equipped with a drive wheel to which the carriages are fixed; the drive wheel can be situated substantially at the equator of the balloon or close to one of the tropics;

the drive wheel has an outer wheel to which the carriages are fixed and an inner wheel fixed to the balloon, the outer and inner wheels being mobile in relation to each other;

at least three of the vertical posts of the tower include guide rails and drive cables, the carriages of the wheel being fastened to said cables;

a motor combined with each drive cable to command the movement of the cable in one direction or the other; a control unit is able to synchronize the drive motors of the cables;

the carriages of the wheel have a stop mechanism capable of lodging between the guide rail and the drive wheel when a drive cable has broken;

the drive wheel includes at least one electrical collector connecting the outer wheel to the inner wheel, at least one carriage of the balloon being capable of carrying an electric power cable passing through one of the posts of the tower;

lighting arranged inside the balloon;

at least one seat fastened to the balloon;

means for returning the balloon to the ground;

means for pulling a balloon inflated with air.

In an alternative embodiment, the present disclosure provides a method of ascending a captive balloon in a tower with a closed perimeter. The method comprises:

unwinding means for returning the balloon to the ground;

actuating braking means when the balloon has traveled more than two thirds of the height of the tower.

In an embodiment, the means for returning the balloon to the ground can be unwound freely and/or the ascent of the balloon can be halted by coming to a stop against the closed top of the tower.

The disclosure also relates to a method of ascending a captive balloon in a tower comprising at least three posts equipped with guide rails and a drive cable, the balloon comprising at least three carriages attached to the drive cables, the method comprising:

actuating at least one drive motor of a cable to raise the balloon in the tower;

putting the drive motor into reverse to return the balloon to the ground.

An advantage of the present disclosure is to provide an improved balloon assembly.

Another advantage of the present disclosure is to provide a method for providing entertainment.

Still another advantage of the present disclosure is to provide an improved method for generating revenue through an amusement ride.

Yet, another advantage of the present disclosure is to provide an improved method for advertising using an amusement ride.

Additional features and advantages are described herein, and will be apparent from, the following Detailed Description and the figures.

### BRIEF DESCRIPTION OF THE FIGURES

FIG. 1 illustrates a diagram of a captive balloon in a tower according to an embodiment of the disclosure.

FIG. 2 illustrates a diagram of a captive balloon in a tower, seen from above, according to an embodiment of the disclosure.

FIG. 3 illustrates a diagram of a captive balloon in a tower, seen from above, according to an embodiment of the disclosure.

FIG. 4 illustrates a diagram of a captive balloon in a tower according to an embodiment of the disclosure.

FIGS. 5a and 5b illustrate a diagram of a captive balloon in a tower according to an embodiment of the disclosure.

FIG. 6 illustrates a top view of the drive wheel of the balloon in FIGS. 5a and 5b.

FIG. 7 illustrates a detail view of the drive system of the balloon in FIGS. 5a and 5b.

FIG. 8 illustrates a diagram of a captive balloon in a tower according to a sixth embodiment of the disclosure.

### DETAILED DESCRIPTION

The present disclosure generally relates to amusement and related rides and more specifically, to captive balloon assemblies and methods of using the captive balloon assemblies. For example, the captive balloon assemblies of the present disclosure can be used to entertain customers, generate revenue and/or display advertisements. The balloon can include seats or a basket to receive and carry passengers riding the balloon within the tower and/or can bear a commercial mark.

In an embodiment, the present disclosure provides a method of entertaining. The method in this embodiment comprises a transporter that includes a sufficient amount of a gas (e.g. hot air, helium) that allows the transporter to ascend and a tower for constraining movement of the transporter. As used herein, the term “ascending” means to move in a limited upwards direction. The transporter can be made to ascend, for example, by heating up the air in the balloon or by using a sufficient amount of helium in the balloon. The transporter can be made to descend, for example, by cooling the air in the balloon or by releasing helium in the balloon.

In another embodiment, the assembly comprises a tether and the transporter is moved at least in part within the tower by the tether. The tether can be, for example, any suitable a rope, chain, or the like, fastened to the transporter so as to limit/control its range of movement.

The transporter can be captive and mobile in the tower. Any suitable number of people can be placed in the transporter, and the transporter can be moved to ascend or descend within the tower. A cable guide (e.g. cable driving system) can be used inside vertical posts of the tower to assist in and/or guide the movement of the transporter.

The transporter can ascend due to the gas allowing the transporter to float upwards within the tower. If the transporter is attached to a tether, the tether can be relaxed/released thereby allowing the transporter to ascend. After reaching a top constraint of the tower (e.g. a cover/closure of the tower or narrowing of the tower's sides), the transporter can be lowered, for example, using the tether and/or by cooling/release of the gas inside the balloon. The transporter can be any suitable shape, size and configuration for allowing people to be carried up and down within the tower in conjunction with the tether.

A waiting area can be provided at the base of the tower for people waiting to ride the transporter. The waiting area can be sheltered and comprise various audio and visual components such as one or more televisions, audio speakers and/or internet devices to keep people entertained while waiting in line or to display advertisements. Refreshments can also be supplied while people are waiting in line to ride the transporter.

In a preferred embodiment, the transporter can comprise a balloon comprising one or more seats. The captive balloon can be held and guided by the structure of the tower. The tower can have a closed perimeter so that the balloon does not ascend higher than the top of the tower. Accordingly, the balloon in the tower can rise and fall the length of the tower. The tower can comprise guide rails to receive carriages integral with the balloon in order to move the balloon in the tower.

The balloon can be rotated as it ascends within the tower. For example, the balloon can rotate at least 360 degrees as the balloon is ascending within the tower. The balloon can rotate at least 360 degrees as the balloon is descending within the tower. The balloon can also be rotated as it remains ascended at a single height within the tower. The balloon can remain ascended in the air within the tower and at any height for any suitable amount of time, such as, for example, 3 minutes or more.

The balloon assembly can be located at any suitable location. For example, the balloon assembly can be located at an amusement park, a tourist attraction, a park, a shopping mall and/or anywhere there is a lot of foot traffic. Details of how the balloon assembly operates can be provided through any suitable medium such as, for example, written materials, television, the internet and combinations thereof. This can provide marketing opportunities for the balloon assembly.

In another embodiment, the present disclosure provides a method for generating revenue, for example, from a balloon assembly. The method in this embodiment comprises providing a balloon assembly comprising a balloon, a tower and a cable driving system and charging a fee for riding the balloon. The balloon can comprise one or more seats and be captive and mobile in the tower. In another embodiment, the entire or parts of the balloon assembly can be sold, rented or licensed in any suitable manner to generate revenue.

The amount of the fee charged can vary, for example, depending on the demand and usage of the balloon assembly. The fee can be received using any suitable method. For example, the fee can be received through sales of individual or bulk tickets for the balloon ride. The fee can be received through renting the balloon assembly. The fee can also be received through licensing the balloon assembly. The renting and the licensing the balloon assembly can be done for any suitable duration.

Other methods of generating fees using the balloon assembly are possible. For example, a fee can be charged for transporting the balloon assembly from a first location to a second location. A fee can be charged for keeping the balloon assembly at a certain location for a specified period of time. In another embodiment, a waiting area comprising one or more television or suitable media devices at a base of the tower can be provided for people waiting to ride the balloon. Fees can be charged and received for selling advertising on the television or media devices. Fees can also be charged for allowing people waiting to ride the balloon to use the television(s) or media devices.

In addition, one or more one souvenirs associated with the balloon assembly can be sold to consumers. The souvenirs can be any suitable items such as clothing items, kitchen products, office products, etc., displaying a picture/logo associated with the balloon assembly. For example, pictures or sketches of the balloon assembly or individual parts thereof can be printed on t-shirts, pens, glasses, buttons, etc. The souvenirs can be sold at or near the balloon assembly location or through other media outlets. In this manner, additional revenue can be generated from the balloon assembly.

In an alternative embodiment, the present disclosure provides a method of advertising. The method in this embodiment comprises providing an assembly comprising a balloon, a tower and a cable driving system. The balloon is captive and mobile in the tower. One or more advertisements can be displayed on an external surface of at least one of the balloon and the tower. The balloon can be moved to ascend or descend within the tower by the cable driving system so as to allow the advertisement(s) to be observed. The balloon can also comprise one or more seats, and an advertisement can be displayed on an external surface of the seat, the balloon and/or the tower.

The advertisement displayed can be in any suitable form. For example, the advertisements can be in the form selected from the group consisting of pictures, slogans, trademarks and combinations thereof. The advertisements can be paid for by any company such as, for example, food companies, entertaining companies, software companies, etc, wishing to advertise on the balloon assembly. The advertisements can also be a part of any signs or components that are attached to the balloon, the seats and/or or the tower. Any suitable fee can be charged for displaying the advertisement(s).

The pictures/slogans/trademarks can be any suitable size. For example, the pictures/slogans/trademarks can cover the entire external surface of the balloon, seats and/or tower or smaller portions the balloon, seats and/or tower. The advertisement(s) can also be a part of any signs or components that are attached to the balloon, the seats and/or or the tower. In an embodiment, the advertisement is clearly seen and identifiable by people at or near the balloon assembly. In another embodiment, the advertisement is clearly seen and identifiable by people located far from the balloon assembly (e.g. 500 feet or more).

In an alternative embodiment, the balloon assembly is used as a sign at a location such as an amusement park, a tourist attraction, a park, a shopping mall or other suitable location. For example, a neon sign can be added to the top of the tower, and/or the balloon could carry the name of the site. The balloon can also be used as a screen to project internally films or pictures. These provide other sources of revenue.

Additional revenue can come from cross marketing operations among, for example, the shopping center or mall, some brands sold in the shopping mall and the balloon ride in the shopping mall. For instance, buying an item in the mall can win a consumer a free balloon ride. Testing a free sample of products such as candies before flights in the balloon can be done in the waiting area of the balloon assembly. A discount for the product can be available if bought in the shopping mall.

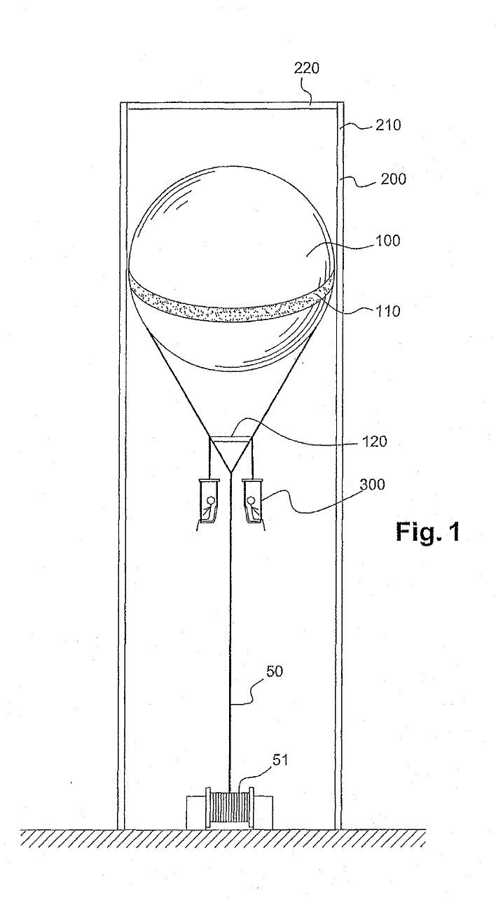

In an embodiment of the present disclosure, FIG. 1 describes an assembly comprising a balloon and a tower. The terms “top”, “bottom”, “horizontal” and “vertical” are used in the following description with reference to the FIGS. and do not limit the implementation of the disclosure. The balloon is defined with an equator constituted by a line describing the largest circle perpendicular to its ascension axis, and with a south pole and a north pole constituted respectively by the point of the balloon closest to the ground and the point of the balloon furthest from the ground. The north pole of the balloon can also be called the top of the balloon. The balloon is said to fly in that it is intended to rise into the air within the tower; this ascent can be carried out by a balloon inflated with a gas which is lighter than air or by a drive system for a balloon inflated with air.

The tower is defined with a vertical structure comprising at least three posts, a top, and a base placed on the ground. The tower can moreover comprise walls connecting the posts of the structure in order to constitute a closed perimeter; the tower can also have cross stays connecting the vertical posts, such as cross spirals or cross ties.

According to the disclosure, an ascending balloon 100 is placed captive in a tower 200. The balloon 100 can comprise an envelope inflated using a gas lighter than air, such as hot air and/or a gas such as helium; the balloon can also be made to rise by cables of a drive system. The balloon can thus rise into the air and move within the height of the tower, optionally carrying one or more passengers placed in one or more seats 300 attached to the balloon.

According to certain embodiments, the balloon is placed in a tower with a closed perimeter (FIGS. 1 to 4). This embodiment is of benefit when the balloon 100 is inflated with a gas which is lighter than air and it rises by itself without a drive system; the walls 210 of the tower then protect the balloon from bad weather and in particular against wind, in order to allow the balloon to rise regardless of the weather conditions.

FIG. 1 shows means for returning the balloon to the ground comprising for example a return cable 50, one end of which is fixed to the balloon and the other end of which is connected to a winch 51 for winding the cable. These return means are necessary when the balloon is inflated with a gas which is lighter than air, and rises without a drive system. Return means for controlling the ascent and commanding the descent of a captive ascending balloon are known per se and in particular from the documents FR-A-2 743 049 and FR-A-2 758 789.

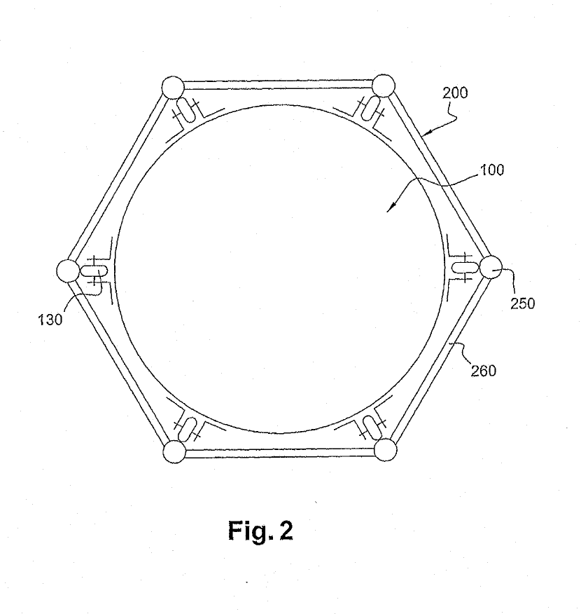

In FIG. 1, the tower 200 is substantially cylindrical with a circular base and the balloon 100 substantially spherical. It will be seen with reference to FIGS. 2 and 3 that these shapes are not limitative. The tower 200 can comprise a top 220 which is closed in order to constitute a safety measure should the return cable 50 of the balloon inflated with a gas which is lighter than air break or be fully unwound. The closed top 220 can also constitute additional protection for the balloon 100 against bad weather, in particular against rain.

The balloon can comprise seats 300 for carrying passengers in order to constitute an attraction. FIG. 1 does not show the seats to scale in relation to the volume of the balloon. The number of seats depends principally on the volume of the balloon, which determines its lifting force. From 2 to 20 seats can be provided according to the size of the balloon. By way of example:

from 2 to 4 passengers for a balloon 9 m in diameter, i.e. approximately 400 m³;

from 4 to 6 passengers for a balloon 10 m in diameter, i.e. approximately 600 m³;

from 10 to 15 passengers for a balloon 14 m in diameter, i.e. approximately 1,500 m³;

from 20 to 30 passengers for a balloon 18 m in diameter, i.e. approximately 3,000 m³.

The seats can be suspended from the load frame 120 which connects the balloon rigging lines to the return cable. The seats are arranged preferentially facing outwards, in order to allow the passengers to view their surroundings. The seats can be distributed in a circle around the return cable, or replaced by a basket having a central opening allowing the return cable to pass through, and in which the passengers can move around freely.

It will be noted that the maximum number of passengers is substantially greater than the number of passengers that can occupy a balloon of the prior art. For the balloons of the prior art, thus manoeuvring in the open air, it is necessary to reserve a part of the balloon's buoyancy for tensioning the return cable, in order to resist the maximum wind that the balloon may encounter as it rises. Even when the weather conditions are extremely favourable, prudence calls for precautions in case of even a light gust of wind. In contrast, for the balloons according to the disclosure, which are guided and protected in a tower, the tension in the return cable can be minimal, as the balloon has no need to resist a side wind; the whole of the balloon's buoyancy can therefore be used for carrying passengers.

By way of example, the comparative performance figures for two balloons of 400 m³, one according to the prior art and the other according to the disclosure, are given in Table 1 below which shows the maximum number of passengers:

TABLE 1

| | Balloon from the | Balloon according to the |
|---|---|---|
| Weather conditions | prior art | disclosure |
| Nil wind | 2 | 3 |
| Wind max 5 m/s | 1 | 3 |
| Wind average 5 m/s | 0 | 3 |

The tower can be between 30 m and 80 m high in order to allow a good panoramic view when passengers are lifted with the balloon and to allow the ascending balloon to be seen from a distance when the envelope of the balloon carries an advertising sign.

The interface between the balloon and the internal walls of the tower is optimized. In particular, the internal diameter of the tower is substantially equal to the diameter of the equator of the balloon, which can be comprised between approximately 8 m and 18 m. The diameter of the balloon is chosen sufficiently small to limit the space occupied by the assembly and allow easy installation in very busy places, such as shopping centres for example, and sufficiently large to allow the balloon to ascend with passengers, if appropriate.

The pressure inside the balloon can be optimized so as to limit the effects of impact against the walls of the tower. Captive balloons in the open air, such as those described in the prior art documents mentioned above, are normally pressurised to prevent deformation under the action of the wind, in order to maintain a good penetration coefficient in the air and limit the drag due to the wind.

The captive balloons of the prior art typically have an overpressure of 100 to 300 Pa at the south pole in relation to the ambient air. This overpressure is increased by the upward thrust of the column of gas at the top, i.e. an additional 100 to 200 Pa. The overpressure at the equator is then 200 to 400 Pa.

The balloon according to the disclosure has no need for overpressure in its lower part. Therefore a nil overpressure can be maintained at the south pole, as is the case for free gas balloons. For example an overpressure of less than 50 Pa can be maintained at the south pole. The overpressure prevailing inside the envelope at its equator will then be reduced in relation to the captive balloons of the prior art, at approximately 50 to 100 Pa. A lower pressure inside the balloon allows the effect of an impact against the walls of the tower to be distributed over a larger surface. By allowing this force to be absorbed over a larger fabric surface, its effects are limited, in particular the risk of tearing. Against this, the surface of the balloon subjected to rubbing is greater and it should be protected effectively.

FIG. 1 thus shows reinforcements 110 on the balloon 100, preferably arranged close to the equator. These reinforcements 110 are intended to come into contact with the internal walls of the tower 200 and allow the envelope of the balloon to be protected against wear or snags due to the rubbing of the balloon against the walls 210 of the tower. The reinforcements 110 can be constituted of an extra thickness of the fabric constituting the envelope or an extra thickness constituted by another material which is more slippery and stronger than the fabric of the envelope, for example nylon or polyester.

FIGS. 2 and 3 show another embodiment of the disclosure in which the base of the tower is in the form of a six-sided polygon. The balloon is seen from above; it can have a spherical shape as in FIG. 1 or oval as in FIG. 3. The base of the tower 200 can have a polygonal shape other than a hexagon, for example a four- to eight-sided polygon.

A tower the base of which is polygonal in shape can easily be erected starting from a metal structure 250. Translucent panels 260 can be used to complete the metal structure and close the perimeter of the tower, in order to protect the balloon without obstructing the view from the seats attached to the balloon or preventing the balloon being seen from outside the tower. The translucent panels can be made of Plexiglas, polycarbonate or glass. The translucent panels form at least the top of the walls of the tower, but can also form the whole of the walls. The metal structure of the tower can be of the free-standing type, with foundations or by guying. A free-standing structure will be preferred, as it takes up little space and is easy to erect and dismantle when the tower has to be erected in very busy places such as shopping centres or urban locations. Structures with foundations or guys are however preferable when the tower is erected with potentially high wind resistance.

FIGS. 2 and 3 show roller elements 130, 230 arranged on the balloon 100 or on the tower 200. These rollers 130, 230 of the balloon and the tower help guide the balloon along the tower.

According to the embodiment shown in FIG. 2, the rollers 130 are arranged on the balloon 100, preferably close to the equator. The equatorial zone of the balloon is stiffened by the thrust of the gas with which the balloon is inflated. Small wheels 130 can be fixed in this zone, for example to the material constituting the reinforcements 110 of the balloon, to follow the vertical movement of the balloon along the tower and reduce the rubbing of the balloon fabric against the internal walls of the tower. The number of small wheels and their spacing depend on the diameter of the balloon and of the shape of the tower. In the case of a cylindrical tower, as in FIG. 1, four to ten small wheels can be distributed equidistantly over the equator of the balloon. In the case of a polygonal tower, such as in FIG. 2, at least one small wheel can be provided opposite each side of the tower or a small wheel opposite each axis of the tower. As shown in FIG. 2, the axis of rotation of each small wheel 130 arranged on the balloon 100 extends in a direction tangential to the balloon in the plane of the equatorial circle.

According to the embodiment of FIG. 3, the rollers 230 are arranged on the internal wall of the tower 200. The rollers 230 of the tower 200 can be arranged along some or each axis of the tower, on the posts 250 constituting the metal structure. The space gap between two consecutive rollers along a single axis of the tower depends on the height of the balloon: in the case of the figure, the balloon comes into contact with the fixed rollers as it rises in the tower. It should be in contact with the rollers as often as possible. For example, these rollers can be arranged on the axises of the tower, at the same height, with a vertical space gap equal to half the height of the balloon.

As shown in FIG. 3, the axis of rotation of the rollers 230 arranged on the tower 200 extends in a substantially horizontal direction, i.e. perpendicular to the axis of the tower.

According to one embodiment, the rollers of the tower 230 can have an axis of rotation which is slightly inclined to the horizontal, for example by up to 30°. Such a tilt of the rollers 230 causes the balloon to pivot when it slides on the roller and allows the balloon to be turned while rising and descending. The rotation of the balloon 100 about its own axis when it moves in the tower 200 can be considerable when the balloon contains seats, in order that the passengers can admire a panoramic view and provide more exciting sensations for the passengers.

Similarly, in the embodiment in which the travelling elements are integral with the balloon, they can be tilted, which rotates the balloon by pressing against the walls of the tower.

Alternatively, the balloon can rise freely without rotary movement up to the top of the tower, then be rotated when it is at the top. This rotary movement is no longer passive as described previously, but carried out by a drive system, for example at least one motor driving small wheels or rollers aligned along a vertical axis of rotation, and not tilted as previously.

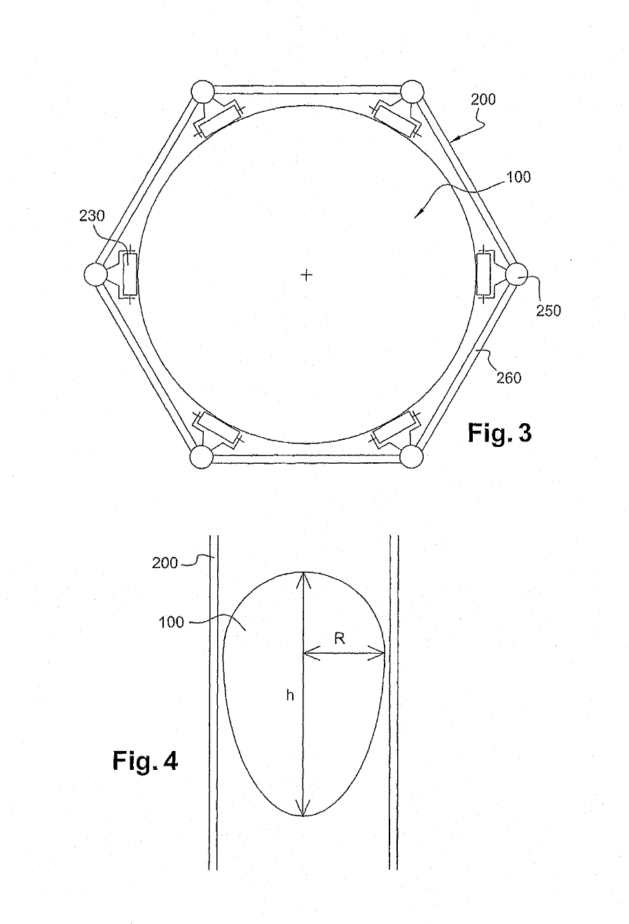

FIG. 4 shows another embodiment of the disclosure in which the balloon 100 has the shape of a water droplet or an upturned egg. The tower 200 of FIG. 4 can have a cylindrical shape with a circular or polygonal base. Such a shape for the balloon 100 is not usual for a captive balloon, but becomes possible within the scope of the present disclosure because the external mechanical stresses are reduced.

The balloon 100 thus has a height h greater than its width, defined by twice its radius R. The width of the balloon is always determined by the diameter at the equator. The width of the balloon is such that the equatorial zone of the balloon substantially fills the cross section of the tower 200. The height of the balloon can reach four times its width; the height-to-width ratio can be comprised between 1.2 and 4.

For a given volume, this elongated shape has a smaller diameter than the spherical shape used for the balloons of the prior art. It therefore allows a balloon of a given volume to be accommodated in a tower with a smaller diameter, which is advantageous in space used and cost. By way of example, a spherical balloon of 600 m³ has a diameter of approximately 10 m. It is accommodated in a tower approximately 10 m diameter and occupies a height equal to its diameter increased by the distance from the south pole to the load frame, i.e. normally 15 m. An elongated balloon of the same volume is obtained with a revolving ellipsoid of diameter 8.30 m for a height of 16.60 m. The elongated balloon therefore allows the diameter of the tower to be reduced, while keeping a capacity (number of passengers and effective flying height) substantially equivalent to that of a spherical balloon of the same volume. Thus, for a given tower, use of an elongated balloon can allow the passenger-carrying capacity to be increased, thus improving profitability.

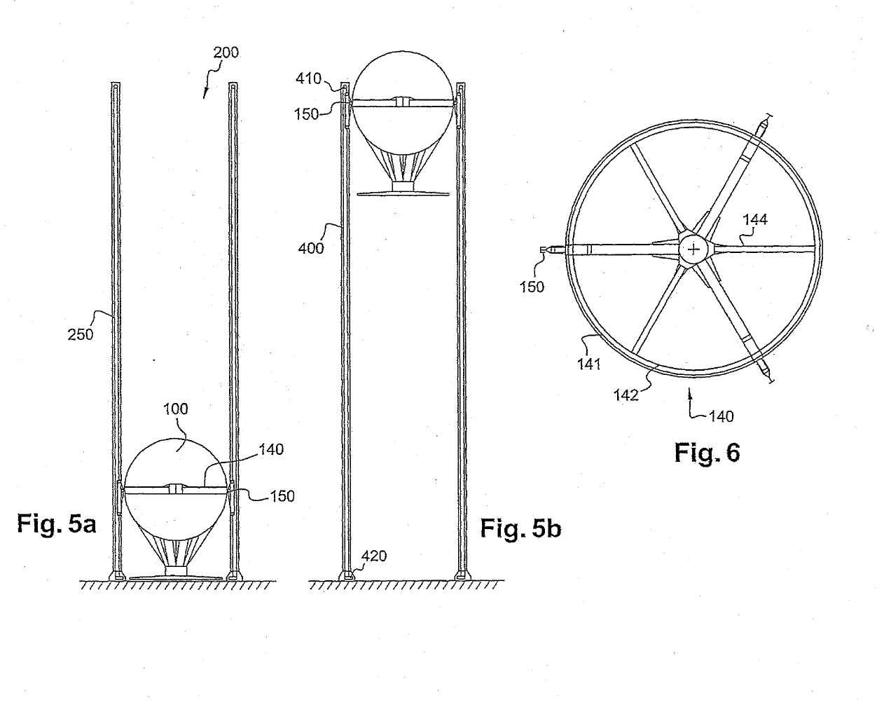

According to another embodiment, the balloon is placed in a tower with a drive system allowing a balloon inflated with air to be raised (FIGS. 5 to 8). The tower has at least three vertical posts containing guide rails capable of receiving respectively three carriages integral with the balloon; the tower guides and holds the balloon during its rise.

FIGS. 5a and 5b show a tower/balloon assembly according to a fifth embodiment of the disclosure, respectively with the balloon on the ground and the balloon raised.

In FIGS. 5a and 5b, two vertical posts only are illustrated, but the tower 200 includes at least three vertical posts 25 which constitute three guiding and holding points of the balloon. The vertical posts can be interconnected by cross stays, such as cross spirals or cross-ties and/or by translucent panels. The vertical posts and the cross stays constitute the structure of the tower, this structure can be of metal.

According to this fifth embodiment, at least three of the vertical posts of the tower 250 comprise guide rails in which are placed drive cables 400, for example Bowden type cables used for lifts. Each cable 400 can extend from a winch 420 situated at the base of the tower to a return pulley 410 situated at the top of the tower and have a return portion from the pulley 410 to the winch 420. The winch can be of the type used for lift installations; it can be combined with a command unit to control the direction of rotation of the cable 400 and regulate its speed; the command unit also controls the synchronization of the movement of the three carriages so that the balloon rises straight up the tower, i.e. by preserving its equator horizontal, in order to prevent the balloon touching the posts and the passengers leaning to one side or the other.

FIGS. 5a and 5b also show the balloon 100 captive in the tower 200. It will be seen in FIG. 5b that the balloon 100 does not include a return cable as in FIG. 1. The balloon 100 of the fifth embodiment is driven by the drive cables 400 and slides along the vertical posts. To this end, the balloon 100 can have a drive wheel 140 which includes at least three carriages 150 intended to be respectively attached to each of the drive cables 400 in order to slide in the guide rails of the posts 250.

The drive wheel can be situated substantially at the equator of the balloon, but it can also be offset towards the north tropic or the south tropic. From the point of view of the drive, this solution is almost as advantageous as the drive at the equator; the forces couple caused by the wind remains small, although it is not nil as it is for an attachment at the equator. An attachment close to the tropics allows the equatorial zone to be left free, for example in case of backlighting or for an advertising message. By “Tropics” is meant the line parallel to the equator, for which a radius forms an angle of 30° with the equatorial plane.

FIG. 6 shows a top view of the drive wheel of the balloon according to the fifth embodiment. The wheel 140 has an outer wheel 141 to which the carriages 150 are fixed and an inner wheel 142 fixed to the balloon 100. The outer wheel 141 is fixed in rotation in relation to the tower 200, since the carriages 150 are accommodated in the guide rails of the posts of the tower 250. Moreover, the inner wheel 142 is fixed in rotation in relation to the balloon but can be mobile in rotation in relation to the tower 200. The inner wheel 142 can have internal radial support beams 144. These support beams 144 are inside the balloon; they ensure that the gap between the carriages 150 remains constant and provides rigidity to the balloon 100 at the equator when the wheel surrounds the equator of the balloon; they can also act as a support for lighting fittings inside the balloon.

The outer and inner wheels are mobile in relation to each other, i.e. they can run in horizontal rotation in relation to each other. A drive mechanism can thus be provided for the balloon which turns the balloon about its own axis during its ascent or descent.

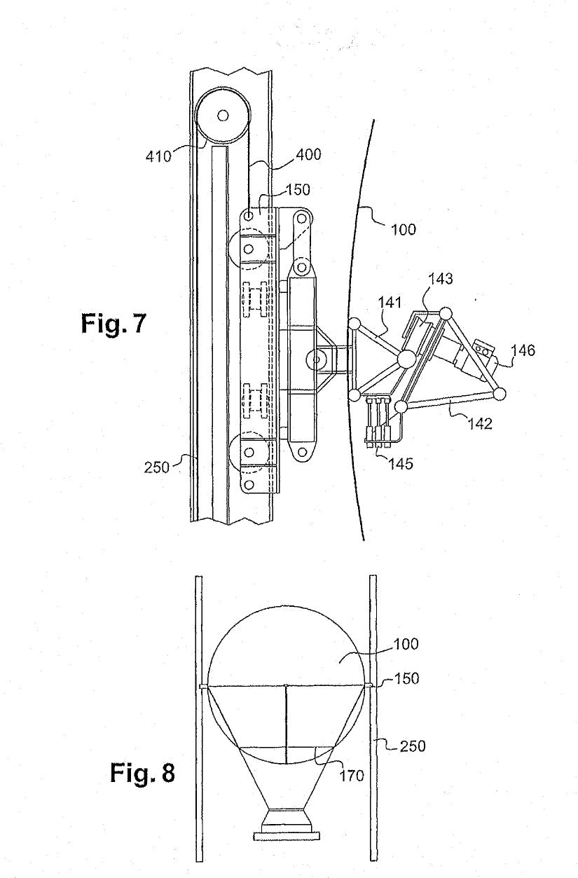

FIG. 7 shows a detailed view of the drive system of the balloon according to the fifth embodiment. FIG. 7 shows a portion of a post 250 of the tower and a portion of the envelope of the balloon 100 captive in the tower. FIG. 7 also shows a carriage 150 accommodated in guide rails of the post 250 and attached to a drive cable 400. The cable 400 has two lengths of cable on either side of the return pulley 410; a first cable length to which the carriage defining a drive path is attached and a second cable length defining a return path to the cable winding winch 420. Each winch can be combined with a motor in order to control the movement of the cable in one direction or the other. There may, for example be three motors synchronized by an electronic unit in order to control the movement of three cables for driving three carriages of the balloon the length of three posts of the tower. Of course, there can be more than three carriages and more than three motors when the tower has more than three vertical posts. There can also be a single motor controlling the movement of three cables.

FIG. 7 also shows a side-section view of the drive wheel 140 of the balloon. According to the example shown, the outer wheel 141, fixed in rotation in relation to the tower, has a triangular structure with one side made integral with the carriage 150 and an opposite top fitted with a pivot pin on which a drive pulley 143 of the inner wheel 142 is hinged. The articulated hinge pulley 143 of the crowns can be connected to a low-power motor 146 which turns the pulley 143 on the pivot pin of the fixed wheel 141, which causes the relative movement of the inner and outer wheels and the rotation of the balloon about its own axis. This motor 146 can be fed by electric collectors 145 sliding in an arc between the two wheels, inner and outer. An electrically conductive path can be provided from an electric power cable, carried by the carriage 150 and passing through the post 250 of the tower to the collector 145, passing through the structure of the outer wheel 141. This electric power cable can be coaxial with the drive cable or be a dedicated cable running alongside the drive cable.

In the case of a balloon carrying passengers on a flight, the use of several synchronized motors to control the movement of several drive cables of the carriages provides redundancy in the case of failure or breakage of a cable in order to improve passenger safety. If a cable breaks, the carriage attached to this cable will slide the length of the post through the action of gravity, which will make the balloon tilt towards the post with the broken cable. The envelope of the balloon will come to rest against the post of the tower which guides and holds the captive balloon; the balloon will therefore not tilt completely. This tilting of the balloon, although not a safety risk, may nevertheless frighten the balloon passengers. Therefore a stop mechanism can be provided on each carriage 150 of the balloon, which compensates for this tilting by preserving a certain distance between the guide rail and the drive wheel when a drive cable is broken. For example, a stop can be provided, shaped to lodge between the carriage and the outer wheel 141 when the carriage slides downwards faster than the wheel. Sets of hinges can also be provided on the carriage such that the carriage deforms when the cable tension is nil (broken cable) in order to constitute a stop between the guide rail and the outer wheel and thus avoid tilting of the balloon.

FIG. 8 shows a sixth embodiment of an assembly according to the disclosure. The balloon inflated with air can be driven in the tower without turning about its own axis by carriages integral with the balloon. For example, a support frame 170 can be provided in the south tropic of the balloon 100 in order to support the pulling of the balloon. The support frame 170 is connected to attachment points situated substantially on the equator, to which the carriages 150 are attached. The carriages 150 are driven by the cables of the posts 250 of the tower as described previously, and pull the balloon upwards by means of the support frame 170. When the balloon descends, the carriages check the descent of the balloon using the support frame 170 as the air-inflated balloon is drawn downwards by gravity. When the balloon is not turning on its own axis, an electricity supply to the lighting fittings inside the balloon can be simply provided through the attachment points of the carriages 150, passing an electricity cable along the posts 250 of the tower.

The assembly according to an embodiment of the disclosure can have lighting means in order to display the balloon and/or the tower in the dark. The lighting can be external with spotlights placed on the ground and/or on the posts of the tower structure. The spotlights are placed such that the beams of light illuminate the balloon and/or the tower structure. Thus, if the envelope of the balloon includes an advertising sign, the latter can be visible from a distance and at night. Lighting can also be arranged inside the balloon in order to illuminate the fabric of the envelope by backlighting. The lighting system present inside the envelope can be supplied from the mains supply by an electric cable. This supply cable can be dedicated or integral with the return cable of the balloon; and can travel by an electric collector between the wheels of the balloon as described with reference to FIGS. 5 to 7.

Flying the balloon of the assembly according to the disclosure can be carried out as follows:

The tower is erected, temporarily or permanently, in a given location, preferably visible at a distance from a busy route. The balloon is placed in the tower and inflated. When the balloon is inflated with a gas lighter than air, it is tethered to the ground by return means, for example comprising a cable attached to a winch. When the balloon is inflated with air, it is attached to the drive cables placed in the posts of the tower.

If appropriate, passengers can be embarked in seats attached to the balloon. When the balloon is inflated with a gas lighter than air, the means for returning the balloon to the ground are then unwound and the balloon rises the length of the tower, offering the passengers a panoramic view through the translucent walls of the tower and displaying itself to the surroundings. The rise of the balloon can give a sensation of free flight if the means for returning the balloon to the ground are unwound freely, i.e. unchecked over the greater part of the distance. The tower can include a venting system at the top which draws the balloon upwards by suction and facilitates the ascent of the balloon by syringe effect.

Braking means, for example a lever linked to the winch of the return means, are then operated over the upper portion of the ascent of the balloon, for example once the balloon has covered at least two thirds of the height of the tower. The ascent of the balloon can be stopped completely by braking on the return means or by the balloon coming to a stop against the closed top of the tower.

If the tower is not closed, it is preferable that the balloon does not travel beyond the upper edge of the tower, as it would then be subject to the wind and could then no longer descend through the opening of the tower. Therefore a tower with a closed top will be preferred, or the length of the return cable will be chosen such that the balloon cannot rise above the tower.

Instead of a cable connected to a winch, the means for returning the balloon to the ground can comprise a horizontal net located close to the top of the tower and equipped with a means of return to the ground. In this case, the balloon can be let loose from the ground and travel freely upwards without its own return means. On reaching the upper part of the tower, it is stopped by the horizontal net. The means of returning the net, for example an assembly constituted by several vertical cords or cables connecting the periphery of the net to one or more return winches, then allow the net to be brought back to the ground, bringing the balloon and its passengers with it. Such a system can be used on its own, in order to offer the passengers carried on seats an impression of leaving in free flight, or as a safety measure if the main return cable breaks when the balloon is held by a cable operated by a return winch.

According to another embodiment, the balloon 100 can be inflated with air and pulled upwards by a system of pulleys and winches. The balloons of the prior art are lifted by the action of a gas lighter than air, which creates an aerostatic thrust. In the device described, the balloon can simply be inflated with air, and rise by means of a drive system as described with reference to FIGS. 5 to 8. It is understood that the winch 420 can be placed at the top of the tower rather than at its base and can pull the balloon upwards.

The drive cables are concealed in the vertical posts of the tower. Thus the balloon appears to rise of its own accord. A drive cable can also be provided which would attach to the top of the envelope of the balloon, and/or which would cross it to attach directly to the passenger lifting system, for example the load frame 120.

In the case of a balloon inflated with air, constant ventilation, for example with an electric fan, allows any leaks of gas, as well as variations in the volume of air due to variations in temperature and surrounding pressures to be compensated for. The ventilation system can run on an on-board battery or be supplied from the mains by means of the drive cable, or a dedicated supply cable separate from the drive cable.

The captive balloon in a tower according to the disclosure constitutes a reliable and compact assembly allowing a balloon to be flown regardless of the weather conditions.

Of course, the present disclosure is not limited to the embodiments described by way of example. In particular, the respective shapes and dimensions of the balloon and the tower can vary without exceeding the scope of the disclosure. Similarly, the means of initiating flight, braking and return of the balloon to the ground can be altered and adapted by a person skilled in the art without exceeding the scope of the disclosure.

In the absence of passengers, a balloon mounted fixed at the top of a tower could also be provided. Such a balloon can be used for advertising; the diameter of the balloon can be greater than that of the tower. The balloon can thus be attached fixed at the top of the tower, for example by means of its two tropics.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of providing entertainment, the method comprising:
providing an assembly comprising a transporter that includes a sufficient amount of a gas that allows the transporter to ascend and a tower for constraining movement of the transporter, the transporter being captive and mobile in the tower;
placing at least one person in the transporter; and
causing the transporter to ascend within the tower.

2. The method of claim 1, wherein the assembly comprises a tether and the transporter is moved at least in part within the tower by the tether.

3. The method of claim 1, wherein the transporter comprises a balloon comprising at least one seat.

4. The method of claim 1 comprising charging the person a fee for riding in the transporter.

5. The method of claim 1 comprising rotating the transporter at least 360 degrees as the transporter is ascending within the tower.

6. The method of claim 1, wherein the transporter remains ascended in the air within the tower for at least 3 minutes.

7. The method of claim 1, wherein the assembly comprises advertising on an external surface of at least one of the transporter and the tower.

8. The method of claim 1 comprising demonstrating how the assembly operates through a medium selected from the group consisting of written materials, television, the internet and combinations thereof.

9. The method of claim 1 comprising providing a sheltered waiting area at a base of the tower for people waiting to ride the transporter.

10. The method of claim 1, wherein the assembly is at a location selected from the group consisting of an amusement park, a tourist attraction, a park, a shopping mall and combinations thereof.

11. The method of claim 1, wherein the tower comprises at least one translucent panel forming a wall in the tower and at least one advertisement is displayed on the translucent panel.

12. A method for generating revenue, the method comprising:
providing a balloon assembly comprising a balloon, a tower and a cable driving system, the balloon comprising at least one seat and being captive and mobile in the tower; and
charging a fee for riding the balloon.

13. The method of claim 12, wherein the fee is received through sales of tickets for the ride.

14. The method of claim 12, wherein the fee is received through renting the balloon assembly.

15. The method of claim 12, wherein the fee is received through licensing the balloon assembly.

16. The method of claim 12 comprising charging a fee for transporting the balloon assembly from a first location to a second location.

17. The method of claim 12 comprising selling at least one souvenir associated with the balloon assembly.

18. The method of claim 12 comprising providing a waiting area comprising at least one television at a base of the tower for people waiting to ride the balloon and receiving a fee from advertising on the television.

19. The method of claim 12 comprising receiving a fee for advertising on an external surface of at least one of the balloon, the seat and the tower.

20. A method for generating revenue from a balloon assembly, the method comprising:
providing the balloon assembly comprising a balloon, a tower and a cable driving system, the balloon comprising at least one seat and being captive and mobile in the tower; and
selling the balloon assembly.

21. A method of advertising, the method comprising:
providing a balloon assembly comprising a balloon, a tower and a cable driving system, the balloon being captive and mobile in the tower;
displaying at least one advertisement on an external surface of at least one of the balloon and the tower; and
causing the balloon to ascend within the tower, the balloon being moved in part within the tower by the cable driving system so as to allow the advertisement to be observed.

22. The method of claim 21, wherein the advertisement is in a form selected from the group consisting of pictures, slogans, trademarks and combinations thereof.

23. The method of claim 21 comprising charging a fee for displaying the advertisement.

24. The method of claim 21, wherein the balloon comprises at least one seat and an advertisement is displayed on an external surface of at least one of the seat, the balloon and the tower.

25. The method of claim 21, wherein the balloon assembly is used as a sign at a location selected from the group consisting of an amusement park, a tourist attraction, a park, a shopping mall and combinations thereof.
